(19) United States
(12) Patent Application Publication
(10) Pub. No.: US 2018/0155861 A1
(43) Pub. Date: Jun. 7, 2018

(54) METHOD FOR PRODUCTION OF ACTIVATED CARBON FABRICS FROM COTTON

(71) Applicants: Razieh Salehi, Fars (IR); Fatemeh Dadashian, Tehran (IR); Mohammad Abedi, Tehran (IR)

(72) Inventors: Razieh Salehi, Fars (IR); Fatemeh Dadashian, Tehran (IR); Mohammad Abedi, Tehran (IR)

(21) Appl. No.: 15/871,985

(22) Filed: Jan. 16, 2018

(51) Int. Cl. D06C 7/04; D06M 10/04; D06M 11/05; D06M 11/71; D06B 3/10; D06B 23/22; F26B 23/04; F26B 21/14

(52) U.S. Cl. CPC D06C 7/04; D06M 10/04; D06M 11/05; D06M 11/71; D06M 2101/40; D06B 23/22; F26B 23/04; F26B 21/14; D06B 3/10

(57) ABSTRACT

An improved method of producing activated carbon fabrics from cotton fabrics involves washing a piece of cotton fabric with a detergent before soaking the washed piece of cotton fabric in an acidic chemical such as phosphoric acid for a specific amount of time, and then drying the soaked piece of cotton fabric in an oven. After the fabric has been dried, it is heated in a furnace which is fed with a flow of nitrogen gas as the temperature of the furnace is gradually increased to a pre-determined temperature and kept at the pre-determined temperature for an extended amount of time, before allowing the temperature to gradually return back to room temperature. After being removed from the furnace and being washed with distilled water to remove any remnants of phosphoric acid, the resulting product is an activated carbon fabric.

### TECHNICAL FIELD

The present subject matter relates generally to production of activated carbon fabrics, and more particularly to a method for producing activated carbon fabrics from cotton fabrics.

### BACKGROUND

In recent years, the use of activated carbon has been increased in a number of industries, as it has been recognized as a highly effective absorbent material for removing gases, vapors, dyes and other organic compounds from vapor and liquid mediums. As a result, activated carbon is often used in filters and masks for removing unwanted chemicals. A wide range of carbonaceous precursors, such as coal, wood, byproducts and agricultural byproducts can be used to produce activated carbon. The activated carbon produced from these materials, however, is in powder and/or granular form. This limits the application of the produced activated carbon, as the form most often desired for use of activated carbon is a cloth or fabric.

To achieve this form of activated carbon, the powder and granular activated carbon is often converted to a fibrous or textile material by mixing it with a binding agent. The process of conversion, however, is often time and labor consuming. Moreover, because of the use of the binding agent, the resulting product often has a reduced active surface area, thereby decreasing the protentional filtering capabilities of the resulting product.

Therefore, a need exists for providing an improved method of producing activated carbon fabrics that is easy to use, reduces time and expense, and provides a higher quality product.

### SUMMARY

A method for producing an activated carbon fabric is provided. In one implementation, the method includes preparing a piece of cotton fabric, washing the prepared piece of cotton fabric, treating the washed piece of cotton fabric with an acidic chemical, and drying the treated piece of cotton fabric with a first heating source. When the treated piece of cotton fabric has dried, the method includes heating the treated piece of cotton fabric with a second heating source while feeding the second heating source with nitrogen gas, removing the heated piece of fabric from the second heating source, and rinsing the heated piece of cotton fabric

### BRIEF DESCRIPTION OF THE DRAWINGS

Features of the subject technology are set forth in the appended claims. However, for purpose of explanation, several implementations of the subject technology are set forth in the following figures.

FIG. 1 is a flow chart for a described process of producing activated carbon fabrics from cotton fabrics, according to an implementation.

FIG. 2 is a microscopic image of a portion of a sample activated carbon fabric produced according to the described process of producing activated carbon fabrics from cotton fabrics.

FIG. 3 is a graph showing the absorption rate of a sample activated carbon fabric produced according to the described process.

FIG. 4 is a graph showing a distribution of pore sizes in a sample activated carbon fabric produced according to the to the described process.

FIG. 5 is a graph showing an elemental activated carbon analysis of a sample activated carbon fabric produced according to the described process.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings. As part of the description, some of this disclosure's drawings represent structures and devices in block diagram form in order to avoid obscuring the invention. In the interest of clarity, not all features of an actual implementation are described in this specification. Moreover, the language used in this disclosure has been principally selected for readability and instructional purposes, and may not have been selected to delineate or circumscribe the inventive subject matter, resort to the claims being necessary to determine such inventive subject matter. Reference in this disclosure to “one embodiment” or to “an embodiment” means that a particular feature, structure, or characteristic described in connection with the embodiment is included in at least one embodiment of the invention, and multiple references to “one embodiment” or “an embodiment” should not be understood as necessarily all referring to the same embodiment.

Recent demands for effective and efficient removal of unwanted chemicals from liquid and vapor mediums, such as air and water, have led to a substantial increase in use of activated carbon materials. This increase has resulted in some recent developments in use of carbon-based waste products as the raw material for producing activated carbon. Carbon-based waste products include agricultural byproducts and some forms of fiber and textiles. The activated carbon produced by these processes, however, is generally in powder and granule form. Utilizing activated carbon as a powder is generally more difficult than using an activated carbon fabric, as powder and granule activated carbons generally exhibit a low amount of flexibility, and are difficult to use in preparing an activated carbon fabric. For example, a piece of activated carbon fabric can simply be used as a filter in an absorbent mask, whereas activated carbon in powder form has to be coated on the surface of the mask, giving rise to questions such as the most appropriate surface to use, the proper amount of coating to apply, and the proper binding agent to utilize. These additional steps and issues result in more time needed for production and ultimately lead to higher costs. Moreover, activated carbon fabrics (ACFs) have faster adsorption kinetics, higher efficiency, and a larger capacity for adsorption of different molecules and species than powder and granule activated carbons. Despite these disadvantages, most currently produced activated carbon is still in powder and granule form as there are no alternative simple means for producing activated carbon fabrics.

A solution is proposed here to solve these issues and others by providing an improved method of producing activated carbon fabrics that utilizes a cotton fabric as a raw material. Given the high percentage of cellulose in cotton, its use as a raw material in producing activated carbon fabrics is advantageous. In one implementation, the method includes washing a piece of cotton fabric with a detergent before treating it with a chemical such as phosphoric acid, and then drying the treated fabric in an oven. After the treated fabric has been dried, it may be placed into an electric furnace which is fed with a continuous flow of nitrogen gas as the temperature rises to heat the treated fabric. Once removed from the furnace and rinsed with distilled water, the resulting product exhibits characteristics of an activated carbon fabric. Thereby, cotton fabric can be converted directly to activated carbon fabric through a simple inexpensive and efficient process that is cost effective.

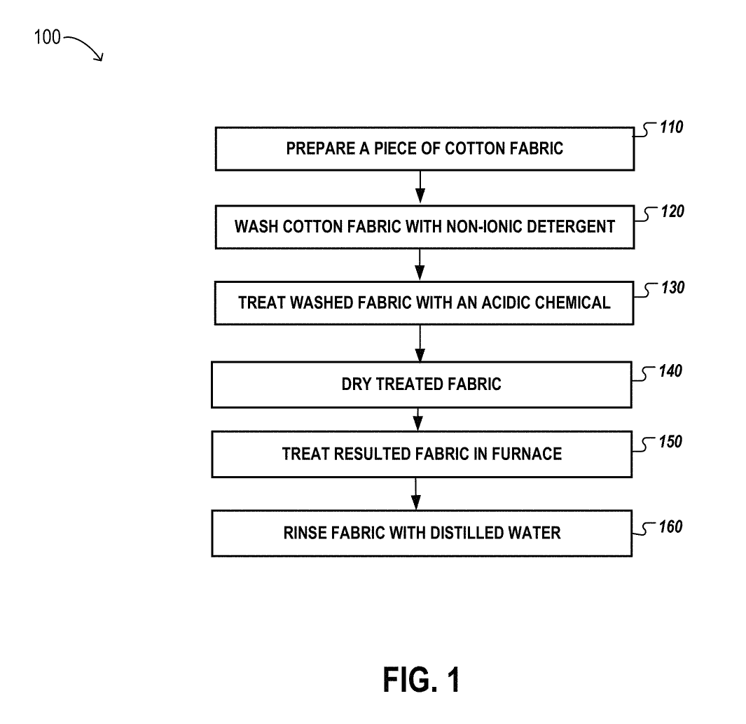

FIG. 1 is a flow diagram depicting an example method 100 used in producing activated carbon fabrics from cotton fabrics. At 110, method 100 includes preparing a piece of cotton fabric according to preferred design requirements. The preparations include selecting a piece of cotton fabric having a specific cotton count and weave. In one implementation, a cotton fabric having approximately 19 counts per centimeters in length and 13 counts per centimeters in length is selected for achieving good results. The selected cotton fabric has a plain weave such as taffeta, for example. Other weave and cotton counts may be used in alternative implementations. After selecting a fabric having the specific desired weave and density, the selected fabric may be cut into a desired size and shape as part of preparing the fabric. The required size and shape of the cotton fabric may depend on design requirements of the desired activated carbon fabric, and/or may depend on any restrictions imposed by the shape and size of the oven and furnace needed to further process the fabric.

Once an appropriate cotton fabric is selected and cut into the desired shape and size, the cotton fabric is washed, at 120, with detergent, such as a non-ionic detergent for a pre-determined amount of time at a pre-determined temperature. A non-ionic detergent may be used due to the water solubility and the superior ability in removing oil of these types detergents. The pre-determined amount of time may be determined based on specific design requirements. For example, the pre-determined amount of time is selected as approximately 30 minutes and the pre-determined temperature is selected as 60 degrees Celsius. Once the cotton fabric is washed with the non-ionic detergent at the pre-determined temperature, it is rinsed before being dried. In one implementation, the cotton fabric is rinsed with distilled water to prevent contamination with any other chemicals.

At 130, the now washed and dried cotton fabric is treated with an acidic chemical. This may involve soaking the cotton fabric in an acidic chemical, such as phosphoric acid, for an extended period of time. The extended period of time may be e.g., between 20 and 30 hours and is approximately 24 hours. The ratio of the acidic chemical to the fabric may be 2 to 1. This means, for example, that an amount of phosphoric acid having twice as much weight as the cotton fabric is used for soaking the fabric. In one implementation, the phosphoric acid used is an 85% aqueous solution.

Once the fabric has been soaked in the acidic chemical for an extended period of time, it is transferred, at 140, to a heating source such as an oven to dry. The temperature of the oven may be between 105 to 110 degrees Celsius. The fabric may remain in the oven until it is completely dry. In one implementation, the fabric remains in the oven for approximately one hour. The dried fabric is, at 150, transferred to another heating source such as an electric furnace to treat the fabric with a nitrogen gas. This is done, for example, by feeding the electric furnace with a continuous flow of nitrogen gas while the temperature is gradually increased. The temperature may be increased, for example, at a rate of approximately 7.5 degrees Celsius per minute until the furnace temperature reaches a desired temperature of, e.g., approximately 500 degrees Celsius. Once the furnace temperature reaches the desired temperature, the fabric may be kept at the furnace for a specific amount of time until it is fully treated. In one implementation, the specific amount of time may be approximately 30 minutes. When the specific amount of time has passed, the furnace is turned off while the fabric is kept in the furnace until its temperature gradually returns to room temperature. The resulting product is now an activated carbon fabric. This product is then thoroughly rinsed, at 160, with distilled water having boiling temperature to completely remove the phosphoric acid from the fabric. After being rinsed, the product may be dried in an oven, a dryer or at room temperature to produce the final product. The resulting activated carbon fabric has a high capacity for absorption, maintains its fabric structure and therefore is ready to for use as a filter or in any other capacity.

Table 1 shows some characteristics of a sample activated carbon fabric produced according to the steps of method 100.

TABLE 1

| Characteristic | Measured Quantity |
|---|---|
| Iodine Value | 595.2 mg I₂/g C |
| Surface Area | 690.8 m²/g |
| Total pore volume | 0.32 cm³/g |
| Average pore diameter | 1.86 nm |
| Percentage of return on weight | 26.5 |
| Percentage of return on size | 38.4 |
| Tensile Strength | 0.259 MPa |
| Bend Strength | 0.122 mNμ |

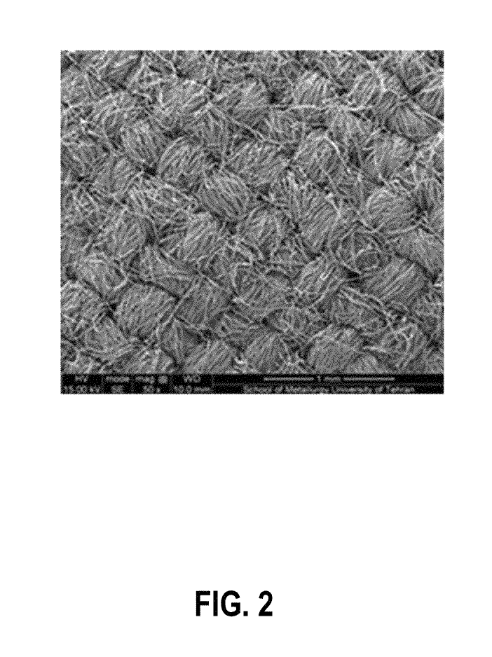

FIG. 2 is a microscopic image of a portion of a sample activated carbon fabric produced according to the process discussed herein. As can be seen in the image, the original weave and structure of the cotton fabric is still well preserved after going through the process of conversion from cotton to activated carbon. Therefore, the activated carbon product produced as described herein continues to hold its fabric form and structure.

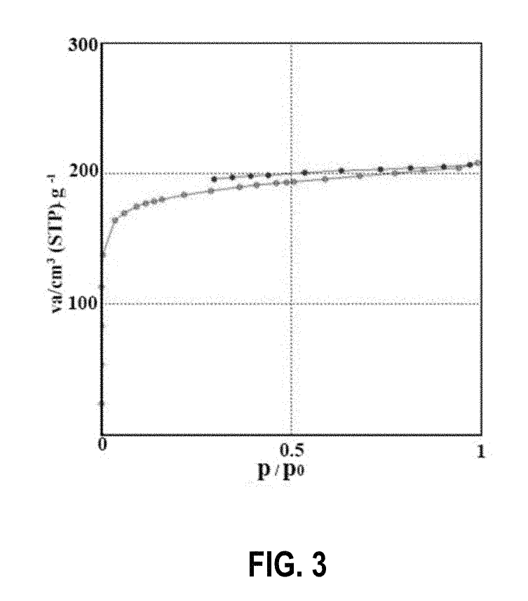

FIG. 3 is a graph of absorption isotherm for a sample activated carbon fabric produced according to the described process. The graph shown in FIG. 3 specifically shows absorption of nitrogen by the sample activated carbon fabric. According to the International Union of Pure and Applied Chemistry (IUPAC) classification, the graph of FIG. 3 is similar to a type I isotherm, often called Langmuir. This is rarely seen in non-porous materials and is suitable for use with microporous compounds. This isotherm has a hysteresis which indicates the presence of a mesoporous material. This shows that the sample activated carbon fabric is highly absorbent.

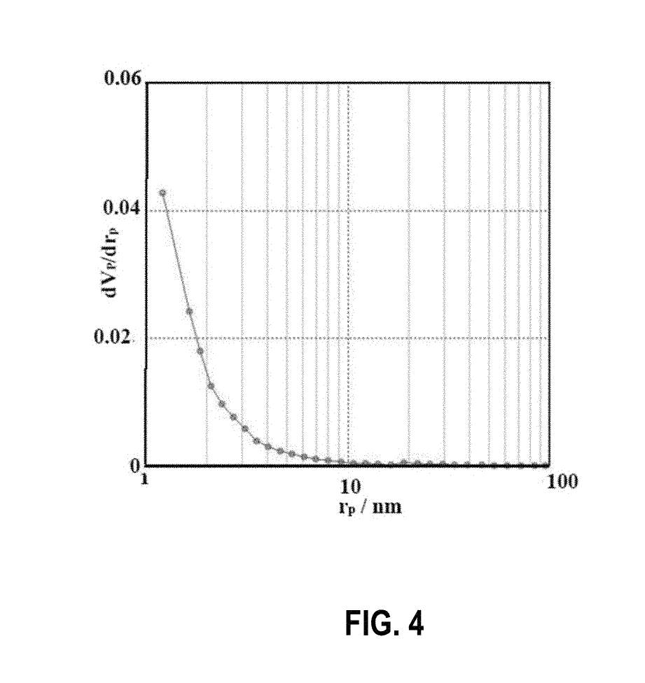

FIG. 4 is a graph for distribution of pore sizes in a sample activated carbon fabric produced according to the process discussed herein. The X axis represents pore radius (rₚ) in nanometers and the Y axis represents derivation of volume of pores to derivation of radius of pores (dVₚ/drₚ). As shown in the graph, most of the pores of the sample activated carbon fabric are micropores in the range of between 1.21 to 3.5 nanometer. In one implementation, the average diameter for pores of the sample activated carbon fabric is 1.86 nanometer. The total volume of pores was determined to be 0.3216 cubic centimeters per gram.

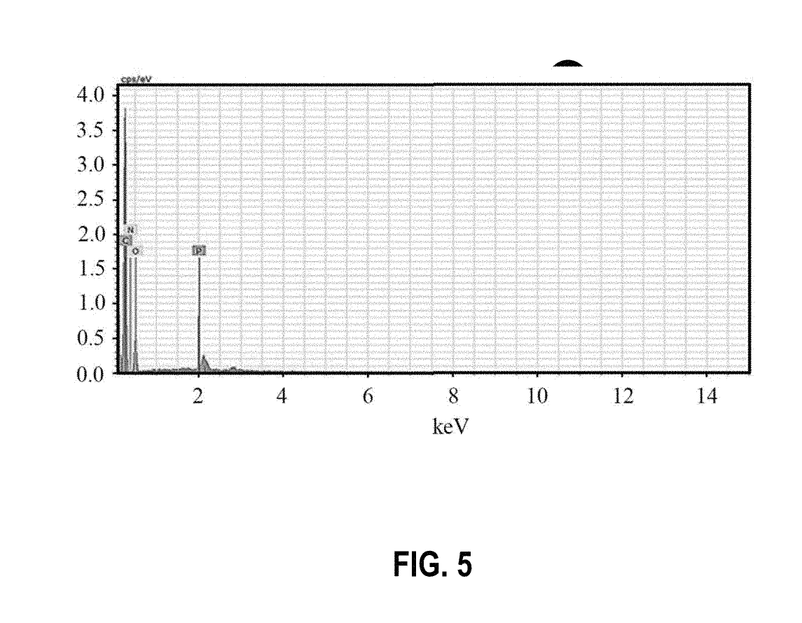

FIG. 5 is a graph showing an elemental activated carbon analysis generated using an Energy-dispersive X-ray spectroscopy (EDX) method of a sample activated carbon fabric produced according to the process discussed herein. As shown in the graph, the produced activated carbon fabric contains about 70.59% carbon, 46.26% oxygen and 0.6% phosphorus. This shows the high efficiency of the carbonization process.

Due to the fact that cotton fabrics are available in different sizes and densities, raw materials for the process discussed herein are generally easily available and inexpensive. Thus, the process of producing activated carbon fabrics from cotton fabrics is easy, efficient and inexpensive and results in producing high quality products that can be directly used for desired purposes.

The separation of various components in the examples described above should not be understood as requiring such separation in all examples, and it should be understood that the described components and systems can generally be integrated together in a single packaged into multiple systems.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various implementations for the purpose of streamlining the disclosure. This method of disclosure is not to be interpreted as reflecting an intention that the claimed implementations require more features than are expressly recited in each claim. Rather, as the following claims reflect, inventive subject matter lies in less than all features of a single disclosed implementation. Thus, the following claims are hereby incorporated into the Detailed Description, with each claim standing on its own as a separately claimed subject matter.

What is claimed is:

1. A method of producing an activated carbon fabric, comprising:
preparing a piece of cotton fabric;
washing the prepared piece of cotton fabric;
treating the washed piece of cotton fabric with an acidic chemical;
drying the treated piece of cotton fabric with a first heating source;
when the treated piece of cotton fabric has dried, heating the treated piece of cotton fabric with a second heating source while feeding the second heating source with nitrogen gas;
removing the heated piece of cotton fabric from the second heating source; and
rinsing the heated piece of cotton fabric.

2. The method of producing an activated carbon fabric of claim 1, wherein washing the piece of cotton fabric comprises washing the piece of cotton fabric with a non-ionic detergent and rinsing the piece of cotton fabric with distilled water.

3. The method of producing an activated carbon fabric of claim 1, wherein the acidic chemical comprises phosphoric acid.

4. The method of producing an activated carbon fabric of claim 3, wherein the acidic chemical comprises phosphoric acid comprises an 85% aqueous solution.

5. The method of producing an activated carbon fabric of claim 1, wherein treating the washed piece of cotton fabric with an acidic chemical comprises soaking the washed piece of cotton fabric in an acidic chemical for an extended period of time.

6. The method of producing an activated carbon fabric of claim 5, wherein the extended period of time comprises 24 hours.

7. The method of producing an activated carbon fabric of claim 1, wherein the first heating source is an oven.

8. The method of producing an activated carbon fabric of claim 7, wherein the treated piece of cotton fabric is dried in the oven at a temperature of between 105 to 110 degrees Celsius.

9. The method of producing an activated carbon fabric of claim 7, wherein the treated piece of cotton fabric is dried in the oven for one hour.

10. The method of producing an activated carbon fabric of claim 1, wherein the second heating source is a furnace.

11. The method of producing an activated carbon fabric of claim 10, wherein the furnace is an electric furnace.

12. The method of producing an activated carbon fabric of claim 10, wherein heating the first the treated piece of cotton fabric in the furnace comprises:
feeding the furnace with the flow of the nitrogen gas while a temperature of the furnace is increased at a pre-determined rate to a desired temperature;
keeping the treated piece of cotton fabric at the furnace at the desired temperature for a specific amount of time; and
turning off the furnace and letting the treated piece of cotton fabric cool down in the furnace until a temperature of the treated piece of cotton fabric returns to room temperature.

13. The method of producing an activated carbon fabric of claim 12, wherein the desired temperature is 500 degrees Celsius.

14. The method of producing an activated carbon fabric of claim 12, wherein the specific amount of time is 30 minutes.

15. The method of producing an activated carbon fabric of claim 1, wherein rinsing the treated piece of cotton fabric comprises rinsing the fabric with distilled water.

16. The method of producing an activated carbon fabric of claim 15, wherein the distilled water is at a boiling temperature.

17. The method of producing an activated carbon fabric of claim 1, further comprising drying the treated piece of cotton fabric after rinsing it.

18. The method of producing an activated carbon fabric of claim 17, wherein drying the treated piece of cotton fabric after rinsing it occurs at an oven.
